(19) United States
(12) Patent Application Publication
(10) Pub. No.: US 2010/0303275 A1
(43) Pub. Date: Dec. 2, 2010

(54) Earpiece and Method for Securing a Device Within the Ear

(76) Inventor: Simon Richard Creek, Northants (GB)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/303,646

(22) PCT Filed: Jun. 5, 2007
(86) PCT No.: PCT/GB07/50315

§ 371 Date: Aug. 19, 2010

(30) Foreign Application Priority Data
Jun. 5, 2006 (GB) 0611054.8

(51) Int. Cl. H04R 25/00

(52) U.S. Cl. 381/380

(57) ABSTRACT

There is described an earpiece for securing a device within an individual's ear comprising a body made from resilient material and means for attaching the earpiece to the device to form an earpiece assembly, wherein the earpiece body is compressible to allow insertion of the earpiece assembly into the ear and the earpiece body is expandable to substantially fill the individual's auricular cavity. The invention has particular utility for securing an earphone or earplug in the ear. A method for manufacturing the earpiece is also provided.

The present invention relates to an earpiece that, when attached to a device to form an earpiece assembly, can be inserted into an individual's auricular cavity, holding the device securely in place in or over the ear canal.

There exists substantial interest in fixing a device securely in or over the ear canal for the purpose of controlling the transmission of sound into the ear. Since there is substantial variation in the size of ear cavities amongst the general population a ‘one size fits all’ approach is generally unsatisfactory in the field of intraauricular devices. There is enormous commercial potential in this area to develop cheap and simple means to improve the fit of such devices. The main advances have been made in relation to securing the fit of earphones to or inside the ear.

Earphones are commercially available with hooks which fit over the top of the auricle to hold the earphone driver unit in position over the ear canal. However, although the hooks are often flexible, and sometimes expandible, these earphones are rarely fully secured in the ear and the hooks are bulky and often uncomfortable after prolonged wear.

US patent application no. 20050220317 describes an ergonomic earphone which can be adjusted to fit the size of different ears. Material is stored within the body of the earphone and is pumped into a silica cover to fill the ear cavity and secure the earphone in place. Although this device addresses the problem of providing an ergonomic earphone, it uses means which are complicated, expensive and unsuitable for use with all intraauricular devices.

Many companies (for example, Radio Partner Custom Earset™) offer custom made molds attached to earphones and earplugs for providing the ultimate security of fit. However, to obtain one of these products the consumer must first make a mold of their ear, and send this to the company, a process which is time-consuming, expensive, and inconvenient.

US 2003/0174853 describes a lightweight and comfortable ear mount for a personal audio-set. The ear mounts have an ear bud mounting portion and an anti-helix mounting portion. The antihelix mounting portion typically forms a compressible loop which, when inserted into the ear, prevents total occlusion of the ear canal, thereby allowing ambient sounds to be heard by the wearer.

There still remains a need to provide cheap and simple means to improve the comfort and security of fit of auricular devices within the ear. A simple and comfortable earpiece is desired which may be fixed to earphones and other devices which have already been purchased by consumers to hold them securely over the ear canal.

In accordance with the first aspect of the invention we provide an earpiece for securing a device within an individual's ear comprising a body made from resilient material and means for attaching the earpiece to the device to form an earpiece assembly, wherein the earpiece body is compressible to allow insertion of the earpiece assembly into the ear and the earpiece body is expandable to substantially fill a portion of the individual's auricular cavity.

The earpiece according to the invention is comfortable, discrete and expandable to fill an individual's ear cavity, thus remaining securely in place even during the most vigorous of exercise. In addition, the earpiece design is adaptable to be fixed to a variety of intraauricular devices and is quick, simple, and inexpensive to manufacture, providing an ideal solution to the problems discussed above.

In the first aspect of this invention, the interaction between the earpiece body and the auricular cavity secures the earpiece assembly in the ear.

Preferably, the earpiece body is reversibly compressible. After compression and insertion into the ear, preferably the earpiece body is expandable to substantially fill the individual's concha. The concha comprises a cavity which can conveniently be utilized to hold the earpiece assembly in place. More preferably, the earpiece body is expandable to substantially fill the individual's cymba concha, wherein the helical crura prevents any further expansion. The earpiece body is thereby secured against the helical crura and holds the whole of the earpiece assembly within the ear. Alternatively, the earpiece body may extend outside the concha and be held in place beneath the folds of the helix.

The earpiece body according to the first aspect of this invention is preferably continuous. This means that preferably no holes penetrate entirely through the dimension of the earpiece body which lies perpendicular to the cross section of the earpiece body which is parallel to the individual's head after insertion. This preferred embodiment of the invention therefore excludes an earpiece body which takes the form of a loop, which is known in the prior art. The continuous nature of the earpiece body allows the earpiece body to substantially, more preferably completely fill the individual's auricular cavity.

When the device is an earphone, the continuous nature of the earpiece body advantageously limits the propagation of background noise into the ear canal, and reduces the emission of sound from the earphone into the surroundings of the individual. A further advantage of the continuous nature of the earpiece body is that it is simpler to manufacture than a loop shape and is likely to fit into the auricular cavity of a larger proportion of the population than the loop design of the prior art.

Preferably, the means for attaching the earpiece to the device fixes the device to the base of the earpiece. Typically, the earpiece is removably detachable from the device. The base of the earpiece is positioned over the ear canal upon insertion of the earpiece assembly into the ear and thus this configuration conveniently locates the device in or over the ear canal. The means for attaching the earpiece to the device may comprise a recess or cavity in the earpiece body into which whole or part of the device may be inserted. This advantageously allows the device to be reversibly secured inside the body of the earpiece.

It is preferred that the body of the earpiece is shaped to substantially match the natural curvature of the auricular cavity, preferably the concha, such that when the earpiece body is compressed and inserted into the ear it subsequently expands to fill the cavity. However, since every individual's ear is different, it is impossible to match the curvature of each ear exactly. It is envisaged that a substantially cardioid or ovoid cross-section of the body of the earpiece, wherein the cross-section is through a plane parallel to the side of the individual's head after insertion of the earpiece assembly into the ear, will provide optimum fit for the majority of individuals. When the cross-section is ovoid in shape it is preferred that the earpiece is wider at the base of the body of the earpiece and narrows along the length of the body to fit the natural narrowing of the auricular cavity, more preferably the concha, towards the upper part of the ear.

The earpiece of the present invention is a three dimensional object wherein the depth is the dimension in the direction perpendicular to its cross section as defined above. The depth is typically substantially uniform or decreases towards one or both ends of the earpiece, again matching the natural curvature of the auricular cavity, more particularly the concha.

The device which is secured is typically an earphone of the “in-ear bud” type which is one of the most popular types of earphone in modern times. Although this type of earphone is extremely popular, many individuals report that the fit of these devices in their ears is poor. The present invention solves this problem by providing a detachable earpiece which can be manufactured and sold separately to earphones, allowing an individual to purchase their “in-ear” earphones of choice and then make an additional earpiece purchase to improve the fit of their earphones if necessary.

Regarding this first aspect of the invention wherein the device is an earphone, in one embodiment of the invention the earpiece comprises a cavity in the earpiece body into which the driver unit of the earphone can be inserted. In this embodiment, the earpiece typically has one or more holes linking the cavity to the outer surface of the earpiece which is positioned over the ear canal when the earpiece is inserted into the ear. This advantageously facilitates the propagation of sound from the earphone into the ear canal. A plurality of holes may be present, as further illustrated in the Figures.

Alternatively, the device which is secured may be an earplug. In this embodiment, the means for attaching the earpiece to the earplug is typically a recess in the earpiece body into which an end of the earplug may be inserted. Alternatively, or additionally, the means for securing the earpiece to the device may comprise a layer of adhesive substance.

The earpiece according to the present invention will help shield out unwanted sounds, which is particularly advantageous when the device secured is an earplug. Furthermore, the earpiece may also insulate against cold air and provide a barrier to the passage of water into the ear.

Alternative devices which may be secured include hearing aids, mobile phone hands-free sets, Bluetooth™ headsets, radio communication systems and medical equipment, for example stethoscopes.

Preferably, the earpiece according to the present invention is made of foam. Suitable foams are attenuating, slow recovery foam, open cell foam and reticulated open cell foam. Many foams have the requisite physical and chemical properties for use as the earpiece described herein. The foam is typically Ethyl Vinyl Ether (EVE), Ethyl Vinyl Acetate (EVA), Polyethylene (PE), Enhanced Polyethylene (EPE), Polyurethane (PU), Polyvinyl Chloride (PVC), Neoprene (Polychloroprene Rubber (CR)), Ethylene Propylene Rubber (EPR), Ethylene Propylene Diene Monomer rubber (EPDM), Styrene Butadiene Rubber (SBR), Silicone (SI) or Latex foam. These are both chemically and biologically inert, and make a soft foam which will expand to return its original shape after compression. Advantageously, these foams also block the passage of external sound into the ear and if the device in the earpiece assembly emits sound then the foam impedes the passage of sound away from the ear also.

Typically the earpiece made from foam will take 0.5 to 10 seconds to expand to its original volume after maximal manual compression. It will be appreciated that, when inserted in an individual's auricular cavity, the earpiece may not fully expand back to its original shape, being constrained by the folds of the auricular cavity.

The foam may be covered in a layer of polymer, for example Polyvinyl Chloride (PVC), to improve its resistance to water and everyday wear, and present a surface upon which a graphic design can be imprinted.

In accordance with a second aspect of the invention we provide an earpiece assembly for securing a device within an individual's ear comprising an earpiece and the device, wherein the earpiece comprises a body made from resilient material, wherein the earpiece body is compressible to allow insertion of the earpiece assembly into the ear and the body of the earpiece is expandable to substantially fill a portion of the individual's auricular cavity to secure the device in the ear.

This second aspect of the invention provides the device in a form which is already associated with the earpiece according to the present invention, thus advantageously allowing an individual to purchase an intraauricular device which will have improved security of fit within their ear. The preferred features of the earpiece forming part of the earpiece assembly are identical to those for the earpiece when offered alone.

The earpiece and device may be an integral unit, that is, manufactured to form a unit which is inseparable into its component parts. Alternatively, the earpiece and the device remain separate entities and detachable in the earpiece assembly.

According to a third aspect of the invention we provide a set comprising a pair of earpieces according to the first aspect of this invention or earpiece assemblies according to the second aspect of this invention wherein the first earpiece or earpiece assembly of the pair possesses reflection symmetry with respect to the second earpiece or earpiece assembly of the pair.

The third aspect of this invention therefore provides a pair of earpieces or earpiece assemblies as described above comprising first and second earpieces or earpiece assemblies suitable for inserting into the left and right ears respectively of an individual.

More than one pair of earpieces or earpiece assemblies may be provided in a set. In this embodiment, the pairs may comprise earpieces of different sizes. Alternatively, the pairs may be the same size and typically the earpieces disposable.

A fourth aspect of this invention provides a method for securing a device within an individual's ear comprising attaching an earpiece to the device, wherein the earpiece comprises a body made from resilient material and means for attaching the earpiece to the device by which an earpiece assembly is formed, wherein in the method the earpiece body is compressed to allow insertion of the earpiece assembly into the ear and the body of the earpiece subsequently expands to substantially fill a portion of the individual's auricular cavity to secure the device in place.

Preferably, the earpiece body subsequently expands to substantially fill the individual's concha. The concha comprises a cavity which can conveniently be utilized to hold the earpiece assembly in place. More preferably, the earpiece body expands to substantially fill the individual's cymba concha, wherein the helical crura prevents any further expansion. The earpiece body is thereby secured against the helical crura and holds the whole of the earpiece assembly within the ear.

In this method, the earpiece assembly is preferably formed by fixing the device to the base of the body of the earpiece. Since the base of the earpiece is positioned over the ear canal when the earpiece is inserted into the ear, this allows the device to be correctly positioned in or over the ear canal.

Typically, the means for attaching the earpiece to the device comprises a recess or cavity in the earpiece body and whole or part of the device is inserted into said recess or cavity to form the earpiece assembly. This represents a simple and convenient way of reversibly fixing the device to the earpiece.

It is envisaged that the invention will be particularly advantageous for securing the fit of earphones in the ear. Therefore, typically the device is an earphone of the “in-ear bud” type. In this embodiment, the means for attaching the earpiece to the earphone typically comprises a cavity in the earpiece body and whole or part of the driver unit of the earphone is inserted into this cavity to form the earpiece assembly. Typically, the cavity is disposed upon the surface of the earpiece facing away from the ear when the earpiece is inserted in the individual's auricular cavity.

Preferably, when the earpiece is inserted into the auricular cavity, the layer of material between the earphone and the ear canal is thin, typically in the range 0.1-3 mm so as not to inhibit the propagation of sound into the ear canal. Alternatively, the layer of material between the earphone and the ear canal may contain a hole or plurality of holes through which the sound may be propagated.

The invention may also find utility for securing the fit of earplugs in the ear and further preventing the entry of unwanted noise into the ear. Typically a method for securing an earplug in an individual's ear comprises inserting the earplug into a recess in the earpiece body to form the earpiece assembly, followed by inserting the earpiece assembly into the individual's ear in order that the earplug is secured in the ear canal. Alternatively, the earplug may be fixed to the earpiece by means of an adhesive substance.

In accordance with a fifth aspect of the invention we provide a method of manufacturing an earpiece for securing a device within an individual's ear wherein the earpiece comprises a body made from resilient material and means for attaching the earpiece to the device to form an earpiece assembly, wherein the earpiece body is compressible to allow insertion of the earpiece assembly into the ear and the body is expandable to substantially fill a portion of the individual's auricular cavity; wherein the method comprises
(i) layering at least one sheet of foam flat over the surface of a metal mold engraved with rimmed recesses of the shape of the earpiece and;
(ii) pressing an upper heated metal mold on the layer(s) of foam to mold and melt-cut the foam to produce the earpiece.

This method provides a convenient and simple way to manufacture the earpiece of the present invention. The method is substantially based on that described in Korean patent no. KR8702033 which details a process for the manufacture of a sponge cover for an earphone.

When step (i) of the method comprises layering one sheet of foam, the method may typically be used to manufacture earpieces suitable for securing the fit of earplugs in the ear. The shape of the rimmed recesses of the mold typically determine the cross-sectional shape of the earpieces being manufactured. The mold is typically constructed in such a way that multiple earpieces may be produced from a single sheet of foam.

Step (i) may comprise layering two or more sheets of foam over the surface of the metal mold. In this case, step (ii) typically further comprises melt-adhesion of the foam layers to form the earpiece. This embodiment is typically used to manufacture earpieces suitable for securing the fit of earbud earphones. In this method, the layer of foam closest to the surface of the metal typically has a pre-formed array of holes passing through the depth of the layer. The holes produce a cavity for the insertion of a device into the earpiece.

Alternatively, in this method, in step (i) three sheets of foam may be layered over the surface of the metal mold and both the middle layer of foam and the layer of foam closest to the surface of the metal (lower layer) have an array of pre-formed holes passing through the depth of the layer. The holes in the middle layer are typically larger than the holes in the lower layer. Alternatively, the holes may be in other layers, such as the middle and the top layer, or just the top layer. When more than one layer has holes, the layers of foam are typically arranged such that the centers of each hole are aligned, so that a cavity is formed in the base of the earpiece when the earpiece is produced in step (ii) of the method. Preferably in this method the holes are circular and have diameters in the range 5-20 mm.

Alternatively, the method of manufacture may comprise foam molding wherein the chemical components of the foam are inserted into a cavity which takes the shape of the earpiece. As the chemical reaction proceeds to form the foam, the foam fills the mold cavity creating the earpiece which can be removed from the mold once the reaction is substantially complete.

Some examples of earpieces and earpiece assemblies according to the present invention will now be described, with reference to the accompanying drawings in which:—

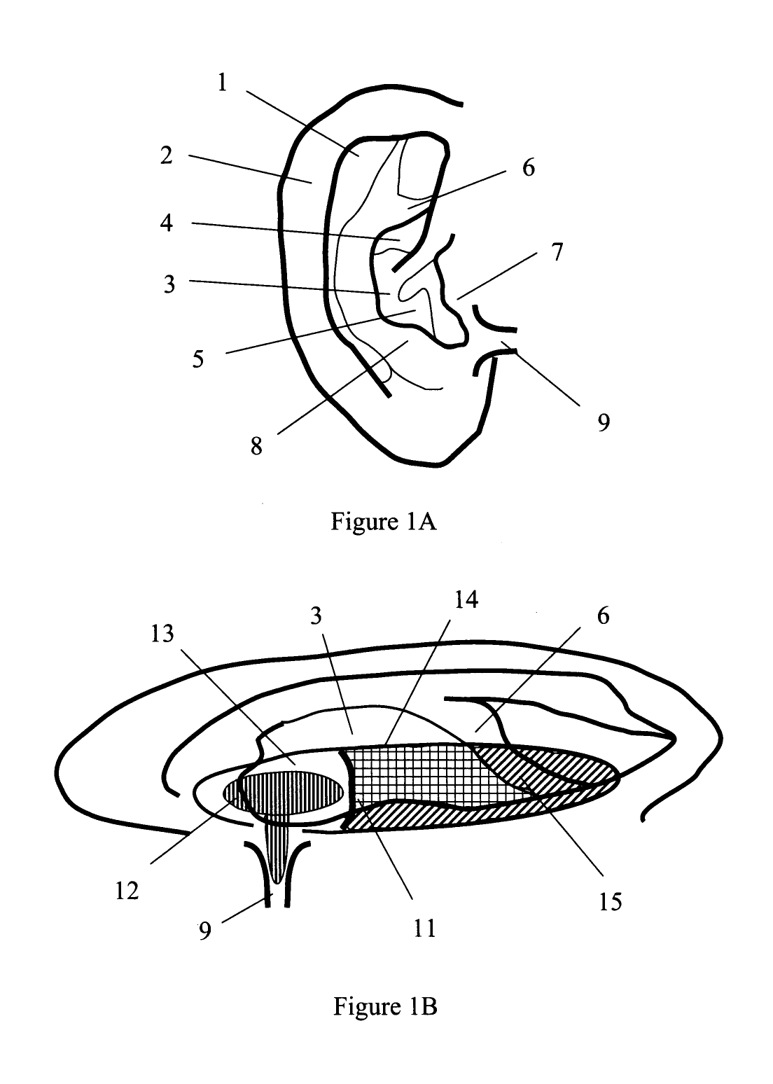

FIG. 1A shows a side-on view of an ear;

FIG. 1B shows a section along the length of the ear in FIG. 1A into which an earpiece assembly according to the present invention has been inserted;

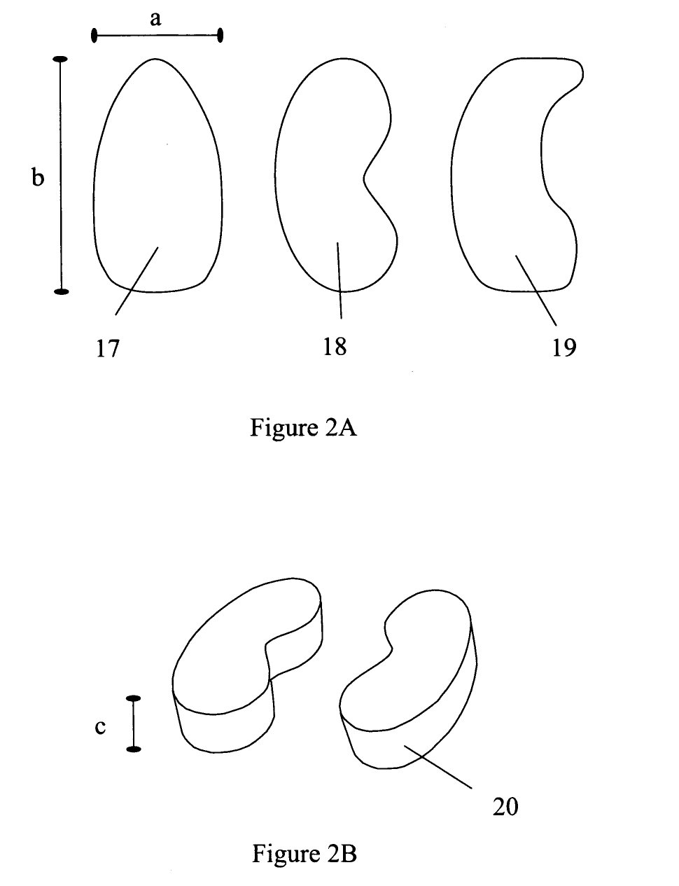

FIG. 2A illustrates various earpiece cross-sectional shapes;

FIG. 2B is a perspective view of the earpiece;

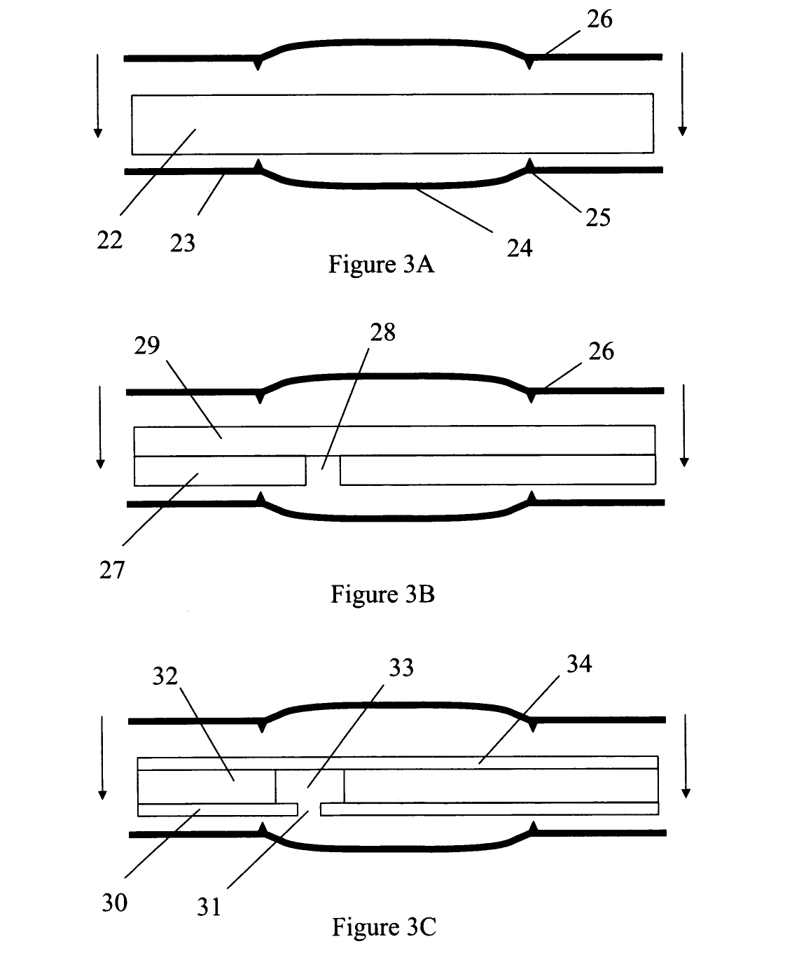

FIG. 3A shows a method of manufacture using one sheet of foam;

FIG. 3B shows a method of manufacture using two sheets of foam;

FIG. 3C shows a method of manufacture using three sheets of foam;

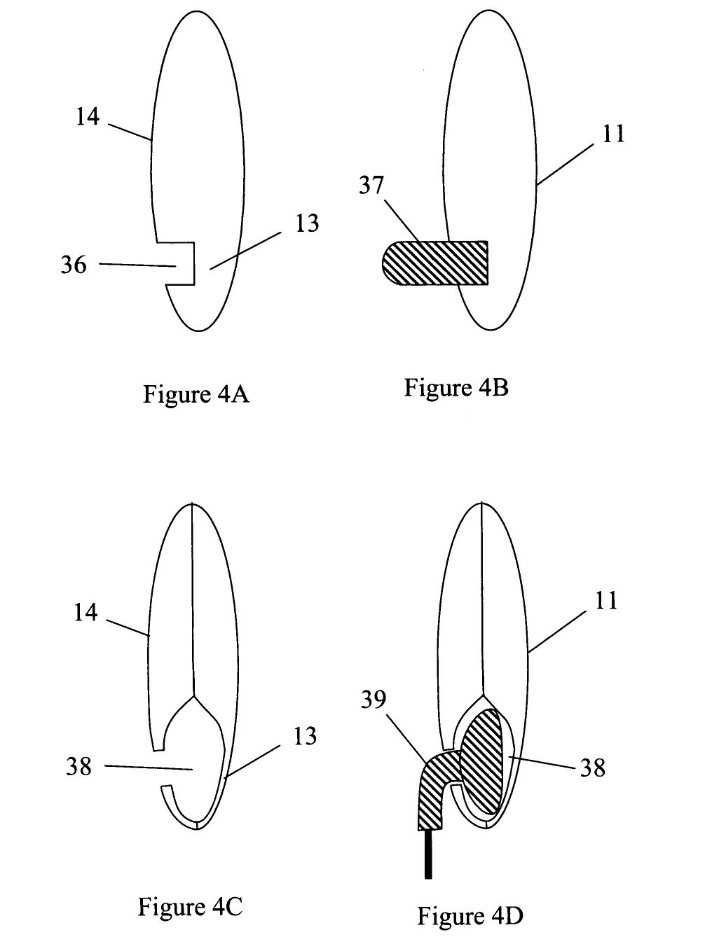

FIG. 4A illustrates an earpiece made from one layer of foam;

FIG. 4B illustrates an earpiece assembly comprising the earpiece in FIG. 4A;

FIG. 4C illustrates an earpiece made from two layers of foam;

FIG. 4D illustrates an earpiece assembly comprising the earpiece in FIG. 4C;

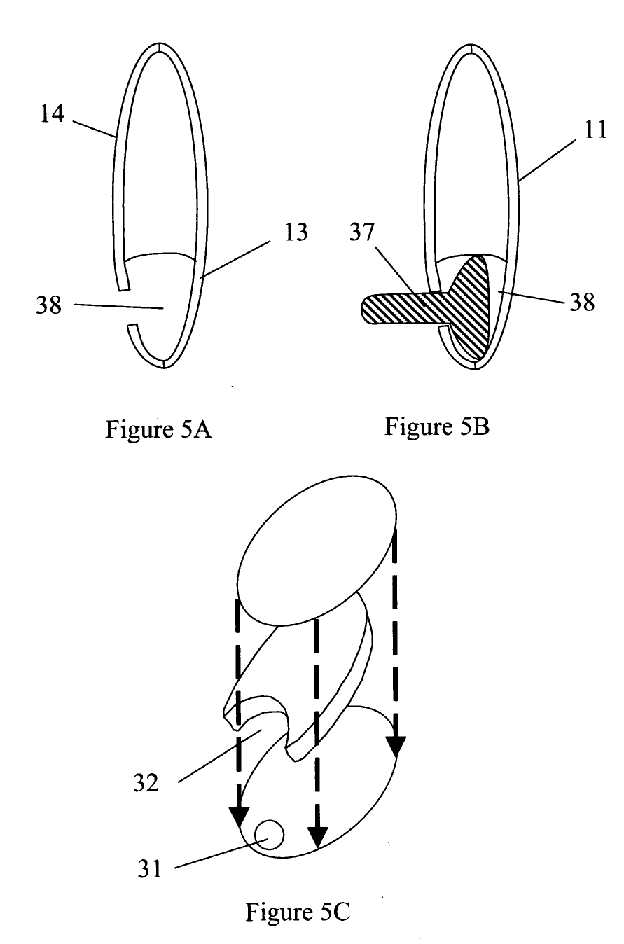

FIG. 5A illustrates an earpiece made from three layers of foam;

FIG. 5B illustrates an earpiece assembly comprising the earpiece in FIG. 5A;

FIG. 5C shows the earpiece in FIG. 5A separated into its component layers;

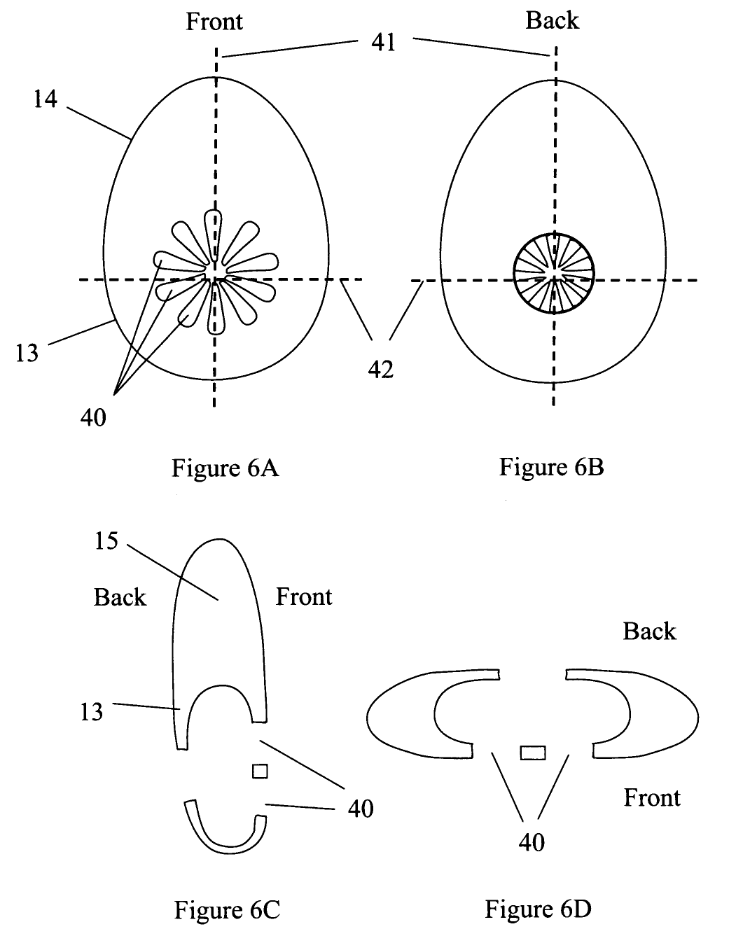

FIG. 6A illustrates the front view of an earpiece containing a plurality of holes in the front surface;

FIG. 6B illustrates the rear view of the earpiece in FIG. 6A;

FIG. 6C illustrates a cross section through the earpiece in FIGS. 6A and 6B; and

FIG. 6D illustrates a cross section through the earpiece in FIGS. 6A and 6B taken through an axis perpendicular to the axis shown in FIG. 6C.

FIG. 1A shows a side-on view of an ear. The outer ear cavity 1 is bounded by the folds of the helix 2. The concha 3 may be divided into the cymba concha 4 and the cavum concha 5 and is surrounded at the upper part by the helical crura 6 and at the lower parts by the tragus 7 and antitragus 8. The auricular cavity can be considered to comprise the outer ear cavity 1 and the concha 3. The terms auricle and outer ear can be used interchangeably. The cavum concha 5 leads to the ear canal 9. FIG. 1B shows a section along the length of the ear in FIG. 1A into which an earpiece assembly 11 according to the present invention has been inserted. The earpiece assembly 11 in this first example comprises an earplug 12 located at the base 13 of the earpiece 14. The earplug has been partially inserted into the ear canal 9. The body 15 of the earpiece 14 fills the concha 3 and is held in place beneath the folds of the helical crura 6. The base 13 of the earpiece 14 is positioned over the ear canal 9.

Referring to FIG. 2, which exemplifies various earpiece cross-sectional shapes according to the present invention, it can be seen from FIG. 2A that the earpiece 14 may take a number of different shapes which the ear will accommodate. Ovoid 17, cardioid 18 and an irregular shape 19 are demonstrated. FIG. 2 shows approximate dimensions for the earpiece, wherein a is typically in the range 10-35 mm, b is typically in the range 20-50 mm and c is typically in the range 2-20 mm depending on the individual and material used for the earpiece. Although the resilient nature of the foam will allow one size to fit a range of ear sizes, it is envisaged that different dimensions may be required for different groups of individuals such as children and adults. As shown in FIG. 2B, the earpieces are generally substantially uniform in depth 20 but it is envisaged that the depth may taper towards one or both ends of the earpiece. FIG. 2B also illustrates a set of earpieces consisting of right and left members of a pair which have mirror symmetry with respect to each another.

FIG. 3A shows a possible manufacturing method wherein a single sheet of foam 22 is laid on a metal mold 23 containing recesses 24 with rims 25. An upper heated metal mold 26 is then pressed down on the foam layer to mold and melt-cut the foam to produce an earpiece. FIG. 3B illustrates the method of FIG. 3A using two sheets of foam wherein the first sheet 27 contains an array of holes 28 and the second sheet 29 contains no holes. Said holes are substantially larger than those naturally present in the foam. When the upper heated metal mold 26 is pressed down on the two foam layers melt-adhesion occurs to bind the layers together.

FIG. 3C illustrates the method of FIG. 3B using three sheets of foam. The first sheet 30 contains holes 31 and the second sheet 32 positioned in the middle of the layered arrangement contains holes of larger diameter 33. The third sheet of foam 34 has no holes above those naturally found in the foam. The first and second sheets of foam are arranged so that the centers of the holes in the first and second sheets respectively are vertically aligned. This arrangement of holes in the foam layers creates the cavity into which the device can be inserted when the earpiece is manufactured.

Earpieces which may have been produced by the manufacturing method illustrated in FIG. 3, but not limited thereto, are shown in FIGS. 4 and 5, which illustrate cross-sections along the dimensions b and c as defined in FIG. 2. FIG. 4A shows an earpiece 14 made from a single layer of foam. The earpiece base 13 comprises a recess 36 into which a device may be inserted. FIG. 4B is an example of an earpiece assembly 11 comprising an earpiece of single layer design wherein the device is an earplug 37 which has been fixed into the recess 36 with an adhesive substance. Other means of attachment are also envisaged. Alternatively, the earpiece and earplug may be manufactured from the same foam in the same molding process. In this case no means of attachment are required.

FIG. 4C shows an earpiece 14 made from two layers of foam. The earpiece base 13 comprises a cavity 38 into which a device may be inserted. FIG. 4D is an example of an earpiece assembly 11 comprising an earpiece of two-layer design wherein the device is an earphone 39 which has been inserted into the cavity 38.

FIG. 5A shows an earpiece 14 made from three layers of foam. The earpiece base 13 comprises a cavity 38 into which a device may be inserted. FIG. 5B is an example of an earpiece assembly 11 comprising an earpiece of three-layer design wherein the device is an earplug 37 which has been inserted into the cavity 38.

FIG. 5C shows the earpiece in FIG. 5A hypothetically separated into the component layers of foam from which it has been manufactured. It will be appreciated that once the layers of foam have been heat-adhered, they will no longer be separable. Holes 31 and 32 in two of the layers form the cavity 38 when the layers of foam are molded to form the final earpiece.

An earpiece produced by foam molding, but not limited to this method of manufacture is shown in FIG. 6.

FIG. 6A shows a front view of an earpiece 14 with a plurality of holes 40 in the base 13 through which sound may be propagated. The term “front” when used herein refers to the face of the earpiece which lies over the ear canal and is in contact with the auricular cavity when the earpiece is inserted into the ear.

FIG. 6B shows the opposing (rear) view of the earpiece in FIG. 6A. The plurality of holes in the front surface of the base can be seen through the rear entrance to the cavity in the base. The term “rear” when used herein refers to the face of the earpiece opposite the front face which remains visible to the eye when the earpiece is inserted into an individual's ear.

FIGS. 6A and 6B also illustrate two axes 41 and 42 through which cross sections are taken to produce FIGS. 6C and 6D.

FIG. 6C shows a cross section of the earpiece in FIGS. 6A and 6B taken through axis 41 along the dimensions b and c, as defined in FIG. 2. The plurality of holes 40 in the front surface of the base 13 are visible. The body 15 of the earpiece is substantially continuous, i.e. there are no cavities penetrating the body.

FIG. 6D shows a cross section of the earpiece in FIGS. 6A and 6B taken through the base of the earpiece, axis 42, along the dimensions a and c as defined in FIG. 2. Again the plurality of holes 40 in the front surface of the base are clearly visible.

Although FIGS. 3-6 illustrate the manufacture of an earpiece according to the present invention made from foam, it is envisaged that other starting materials may be used, for example, non-foamed polymers or gels.

1. An earpiece for securing a device within an individual's ear comprising a body made from resilient material and means for attaching the earpiece to the device to form an earpiece assembly,
wherein the earpiece body is compressible to allow insertion of the earpiece assembly into the ear and the earpiece is expandable to substantially fill a portion of the individual's auricular cavity.

2. An earpiece according to claim 1 wherein the earpiece body is reversibly compressible.

3. An earpiece according to claim 1 wherein the earpiece body is substantially continuous in a direction perpendicular to the direction defined by the plane parallel to the side of the individual's head after insertion of the earpiece assembly into the individual's ear.

4. An earpiece according to claim 1 wherein the earpiece body is expandable to substantially fill the individual's concha.

5. An earpiece according to claim 4 wherein the earpiece body is expandable to substantially fill the individual's cymba concha, wherein the helical crura prevents any further expansion.

6. An earpiece according to claim 1 wherein the means for attaching the earpiece to the device fixes the device to the base of the body of the earpiece, wherein said base is positioned over the ear canal upon insertion of the earpiece assembly into the ear.

7. An earpiece according to claim 1 wherein the means for attaching the earpiece to the device comprises a recess or cavity in the earpiece body into which whole or part of the device may be inserted.

8. An earpiece according to claim 1 wherein the body of the earpiece is substantially cardioid in a cross-section through the plane parallel to the side of the individual's head after insertion of the earpiece assembly into the individual's ear.

9. An earpiece according to claim 1 wherein the body of the earpiece is substantially ovoid in a cross-section through the plane parallel to the side of the individual's head after insertion of the earpiece assembly into the individual's ear.

10. An earpiece according to claim 9 wherein the cross-section of the earpiece is wider at the base of the body of the earpiece and narrows along the length of the body.

11. An earpiece according to claim 8 wherein the depth of the earpiece is substantially uniform or decreases towards one or both ends of the earpiece, wherein the depth is the dimension of the earpiece in the direction perpendicular to the cross-section.

12. An earpiece according to claim 1 wherein the device which is secured is an earphone or an earplug.

13. An earpiece according to claim 12 wherein the means for attaching the earpiece to the earphone comprises a cavity in the earpiece body into which the earphone driver unit may be inserted.

14. (canceled)

15. An earpiece according to claim 12 wherein the device which is secured is an earplug and wherein the means for attaching the earpiece to the earplug comprises a recess in the earpiece body into which one end of the earplug may be inserted.

16. An earpiece according to claim 1 wherein the means for attaching the earpiece to the device comprises a layer of adhesive substance.

17. An earpiece according to claim 1 wherein the earpiece is made of foam.

18. An earpiece according to claim 17 wherein the foam is EVE, EVA, PE, EPE, PU, PVC, Neoprene (CR), EPR, EPDM, SBR, Silicone or Latex foam.

19. An earpiece assembly for securing a device within an individual's ear comprising an earpiece and the device, wherein the earpiece comprises a body made from resilient material, wherein the earpiece body is compressible to allow insertion of the earpiece assembly into the ear and the body of the earpiece is expandable to substantially fill a portion of the individual's auricular cavity to secure the device in the ear.

20. (canceled)

21. An earpiece assembly according to claim 19 wherein the earpiece and device are an integral unit.

22. An earpiece assembly according to claim 19 wherein the earpiece is detachable from the device.

23. A set comprising
a pair of
(1) earpieces, wherein each earpiece is an earpiece for securing a device within an individual's ear comprising a body made from resilient material and means for attaching the earpiece to the device to form an earpiece assembly,
wherein the earpiece body is compressible to allow insertion of the earpiece assembly into the ear and the earpiece is expandable to substantially fill a portion of the individual's auricular cavity, or
(2) earpiece assemblies wherein each earpiece assembly is an earpiece assembly for securing a device within an individual's ear comprising an earpiece and the device, wherein the earpiece comprises a body made from resilient material, wherein the earpiece body is compressible to allow insertion of the earpiece assembly into the ear and the body of the earpiece is expandable to substantially fill a portion of the individual's auricular cavity to secure the device in the ear
wherein the first earpiece or earpiece assembly of the pair possesses reflection symmetry with respect to the second earpiece or earpiece assembly of the pair.

24. A method for securing a device within an individual's ear comprising attaching an earpiece to the device, wherein the earpiece comprises
a body made from resilient material and means for attaching the earpiece to the device by which an earpiece assembly is formed,
wherein in the method the earpiece body is compressed to allow insertion of the earpiece assembly into the ear and the body of the earpiece subsequently expands to substantially fill a portion of the individual's auricular cavity to secure the device in place.

25. A method according to claim 24 wherein the earpiece is reversibly compressible.

26. A method according to claim 24 wherein the earpiece is substantially continuous in a direction perpendicular to the direction defined by the plane parallel to the side of the individual's head after insertion of the earpiece assembly into the individual's ear.

27. A method according to claim 24 wherein the earpiece body expands to substantially fill the individual's concha.

28. A method according to claim 27 wherein the earpiece body expands to substantially fill the individual's cymba concha, wherein the helical crura prevents any further expansion.

29. A method according to claim 24 wherein the earpiece assembly is formed by fixing the device to the base of the body of the earpiece, wherein said base is positioned over the ear canal when the earpiece assembly is inserted into the ear.

30. A method according to claim 24 wherein the means for attaching the earpiece to the device comprises a recess or cavity in the earpiece body and whole or part of the device is inserted into said recess or cavity to form the earpiece assembly.

31. A method according to claim 24 wherein the device which is secured is an earphone or an earplug.

32. A method according to claim 31 wherein the means for attaching the earpiece to the earphone comprises a cavity in the earpiece body and whole or part of the earphone driver unit is inserted into said cavity to form the earpiece assembly.

33. (canceled)

34. A method according to claim 31 wherein the device which is secured is an earplug and wherein the means for attaching the earpiece to the earplug comprises a recess in the earpiece body and one end of the earplug is inserted into said recess to form the earpiece assembly.

35. A method according to claim 24 wherein the device is secured by means of an adhesive substance.

36. A method of manufacturing an earpiece for securing a device within an individual's ear wherein the earpiece comprises a body made from resilient material and means for attaching the earpiece to the device to form an earpiece assembly,
wherein the earpiece body is compressible to allow insertion of the earpiece assembly into the ear and the body is expandable to substantially fill a portion of the individual's auricular cavity; wherein the method comprises
(i) layering at least one sheet of foam flat over the surface of a metal mold engraved with rimmed recesses of the shape of the earpiece and;
(ii) pressing an upper heated metal mold on the layer(s) of foam to mold and melt-cut the foam to produce the earpiece.

37. A method according to claim 36 wherein in step (i) two or more sheets of foam are layered over the surface of the metal mold and step (ii) further comprises melt-adhesion of the foam layers.

38. A method according to claim 37 wherein the layer of foam closest to the surface of the metal mold has an array of holes passing through the depth of the layer.

39. A method according to claim 38 wherein in step (i) three sheets of foam are layered over the surface of the metal mold and the middle layer of foam also has an array of holes passing through the depth of the layer of a larger size than the holes in the lower layer; wherein the layers of foam are arranged such that the centers of each hole are aligned, so that a cavity is formed in the base of the earpiece when the earpiece is produced in step (ii) of the method.

40. A method according to claim 39 wherein the holes are circular and have diameters in the range 5-20 mm.

41. A method of manufacturing an earpiece for securing a device within an individual's ear wherein the earpiece comprises a body made from resilient material and means for attaching the earpiece to the device to form an earpiece assembly,
wherein the earpiece body is compressible to allow insertion of the earpiece assembly into the ear and the body is expandable to substantially fill a portion of the individual's auricular cavity; wherein the method comprises foam molding.

42. (canceled)
